(19) United States
(12) Patent Application Publication
(10) Pub. No.: US 2021/0278142 A1
(43) Pub. Date: Sep. 9, 2021

(54) DOUBLE-SHELL PHASE CHANGE HEAT STORAGE BALLS AND PREPARATION METHOD THEREOF

(71) Applicant: Wuhan University of Science and Technology, Wuha (CN)

(72) Inventors: Huazhi Gu, Wuhan (CN); Qiulin Xia, Wuhan (CN); Meijie Zhang, Wuhan (CN); Ao Huang, Wuhan (CN); Lvping Fu, Wuhan (CN); Fengming Zhou, Wuhan (CN); Haifeng Li, Wuhan (CN)

(73) Assignee: Wuhan University of Science and Technology

(21) Appl. No.: 17/330,427

(22) Filed: May 26, 2021

(30) Foreign Application Priority Data
May 6, 2020 (CN) 202011194508.1

(51) Int. Cl. F28D 20/02; C09K 5/06; C04B 35/117; C04B 35/636; C04B 35/626; C04B 35/64

(52) U.S. Cl. CPC F28D 20/023; C09K 5/063; C04B 35/117; F28D 2020/0047; C04B 35/6264; C04B 35/62695; C04B 35/64; C04B 35/636

(57) ABSTRACT

A double-shell phase change heat storage balls and preparation method thereof is disclosed. The technical scheme is as follows. Paraffin is placed in oven, and organic ignition loss is added to obtain paraffin melt containing the ignition loss; metal balls is immersed in the paraffin melt containing the ignition loss, and cooled naturally to obtain the metal balls coated by ignition loss and paraffin; alumina refractory slurry is placed in a pan granulator, and the metal balls coated by ignition loss and paraffin is added, pelletized, and dried to obtain alumina composite phase change heat storage ball bodies; mullite refractory slurry is placed in a pan granulator, alumina composite phase change heat storage ball bodies is added, pelletized, dried, and placed in a muffle furnace. The temperature is raised to 1200-1600° C. by three systems and maintained. After naturally cooling, the double-shell phase change heat storage balls are prepared.

### TECHNICAL FIELD

The present disclosure relates to the phase change heat storage balls, and more specifically, to a double-shell phase change heat storage balls and preparation method thereof.

### BACKGROUND

The phase change energy storage technology stores energy by using the property of absorbing and releasing heat during the phase change material state change. When the ambient temperature is higher than the phase change temperature, the phase change material melts or vaporizes and absorbs heat; on the contrary, when the ambient temperature is lower than the phase change temperature, the phase change material condenses or solidifies and releases heat, thereby achieving the effect of adjusting the ambient temperature and energy storage. Thorough utilization of the latent heat storage characteristics of the phase change material, various requirements of building temperature adjustment and energy conditioning, residual heat recovery and storage, auxiliary heat storage and solar heat storage can be achieved.

An aluminum-based alloy is an excellent metal-based phase change heat storage material, and has a wide application prospect in the field of high-temperature heat storage. However, the success of the alloy heat storage application depends on the heat storage performance of the heat storage material itself and the compatibility of the heal storage alloy with the container housing material. Because the aluminum alloy material has liquid corrosiveness, chemical, electrochemical and physical reactions may occur between the aluminum alloy material and the container housing during long-term endothermic and exothermic cycling. As a result, the housing is corroded and the safe operation of the whole heat storage system is endangered. Preparing the phase change material into composite phase change heat storage particles is one of the key techniques to solve the described problems. The composite phase change heat storage particles are composed of a phase change material as a core and a coating material as a shell. Since the composite phase change heat storage particles have advantages such as no corrosiveness, preventing medium leakage, high heat storage density, constant temperature during phase change, and the like, they have become hot spots which have been studied in recent years.

In recent years, composite phase change heat storage materials of aluminum or aluminum silicon alloy have been studied in large quantities. For example, a patent technology, “metal ceramic having a phase change heat storage function and manufacture thereof” (20131029397.X), uses an aluminum silicon alloy powder or a modified powder thereof and a corundum powder as raw materials, adds MgO as a sintering aid, and prepare a metal ceramic through raw material weighing, dry mixing, fine grinding, molding and roasting; a patent technology, “phase change heat storage material” (201811578090.7), uses corundum powder, quartz sand powder and aluminum silicon alloy powder as main raw materials, presses and molds after mixing with a phenolic resin, and subjects to high-temperature roasting to produce a phase change heat storage material. In the above technology, the phase change material is directly mixed with the matrix material, and the finished product is obtained after pressing and heat treatment. However, the content of the aluminum silicon alloy powder in the phase change heat storage material prepared by this method is limited, and when the content of the aluminum silicon alloy powder is relatively high, the aluminum or aluminum silicon alloy powder is easy to leak and overflow after melting during roasting, the sample is cracked, and the heat storage density is severely decreased.

There are also some schoolers investigating the preparation of aluminum or aluminum silicon alloy phase change heat storage particles. A patent technology, “large-diameter phase change heat storage particle and preparation method thereof” (201910007853.0), repeats washing of aluminum silicon alloy powder with acid and deionized water, and performs drying and roasting treatment at different temperatures to prepare a large-diameter phase change heat storage particle. The preparation process cost of the technology is high, the yield is low, and it is not easy for industrial mass production. A patent technology, “high-temperature phase change heat storage microcapsule with dense alumina shell and preparation method therefor” (201810202184.8), uses aluminum silicon alloy powder as a raw material, and obtains the high-temperature phase change heat storage microcapsule with dense alumina shell through pre-treating by a treatment liquid and roasting. The shell prepared by the technology is mainly alumina, and due to the poor thermal shock stability of the alumina, the cycle life of the prepared high-temperature phase change heat storage microcapsule with dense alumina shell is short.

### SUMMARY

The present disclosure aims to overcome the drawbacks in the prior art, and an object of the present disclosure is to provide a preparation method for a double-shell phase change heat storage balls with situ packaging, good sealing, strong stability, easy controllability, uniform shell thickness, and easy industrial production. The prepared double-shell phase change heat storage balls have high heat storage capacity, good thermal shock stability, good heat cycle performance, long product life, high use temperature, wide application range and high heat utilization rate.

In order to realize the above object, the steps of the technical scheme adopted in the disclosure are as follows:

Step 1: preparing raw materials with 50-70 wt % of a paraffin and 30-50 wt % of an organic ignition loss, placing the paraffin in an oven at 80-110° C. for 1-2 h to obtain a paraffin melt; then adding the organic ignition loss to produce a paraffin melt containing the ignition loss; then immersing metal balls in the paraffin melt containing the ignition loss for 10-20 s, and naturally cooling the immersed metal balls in a fume hood to prepare metal balls coated by ignition loss and paraffin;

Step 2: placing 15-35 wt % of an alumina refractory slurry in a pan granulator, then adding 65-85 wt % of the metal balls coated by ignition loss and paraffin into the pan granulator, rotating the pan granulator at 10-20 r/min for 0.5-1 h, taking out and placing the pelletized metal balls in a fume hood for 4-6 h, and then maintaining a temperature at 80-110° C. for 20-24 h to prepare alumina composite phase change heat storage ball bodies;

Step 3: placing 25-40 wt % of a mullite refractory slurry in a pan granulator, then adding 60-75 wt % of the alumina composite phase change heat storage ball bodies into the pan granulator, rotating the pan granulator at 10-20 r/min for 0.5-1 h, taking out and placing the pelletized ball bodies in a fume hood for 4-6 h, and then placing in an oven, maintaining at 80-110° C. for 20-24 h to prepare an alumina-mullite double-shell phase change heat storage ball bodies;

Step 4: placing the alumina-mullite double-shell phase change heat storage ball bodies in a muffle furnace, increasing a temperature to 500-550° C. at a rate of 5-10° C./min, maintaining the temperature for 2-4 h, then increasing the temperature to 850-1100° C. at a rate of 3-5° C./min, maintaining the temperature for 3-5 h, then increasing the temperature to 1200-1600° C. at a rate of 2-5° C./min, maintaining the temperature for 3-5 h, and naturally cooling to room temperature to produce double-shell phase change heat storage balls.

A preparation method for the alumina refractory slurry includes:

premixing 80-90wt % of a corundum fine powder, 3-5wt % of an α-alumina powder, 4-8wt % of a Guangxi clay, 1-3wt % of a silica fine powder, 1-2wt % of a calcium lignosulphonate and 1-2wt % of a dextrin to obtain a premix; then adding 6-8 wt % of an aluminum dihydrogen phosphate solution and 8-10 wt % of water to the premix and stirring uniformly to prepare the alumina refractory slurry.

A preparation method for the mullite refractory slurry includes:

premixing 68-82 wt % of a mullite fine powder, 6-10 wt % of an α-alumina powder, 4-8 wt % of a Guangxi clay, 5-9 wt % of a silica fine powder, 1-2 wt % of a calcium lignosulphonate and 2-3 wt % of a dextrin to obtain a premix; then adding 6-8 wt % of an aluminum dihydrogen phosphate solution and 8-10 wt % of water to the premix and stirring uniformly to prepare the mullite refractory slurry.

The organic ignition loss is one kind of starch, sawdust and rice bran husk, and a particle size of the organic ignition loss is less than or equal to 180 μm.

The metal balls are one kind of aluminum balls, aluminum silicon alloy balls, aluminum silicon iron alloy balls, aluminum silicon nickel alloy balls and silicon magnesium alloy balls, and a particle size of the metal balls is 5-30 mm;

an Al content of the aluminum balls is greater than or equal to 97 wt %; an Al content of the aluminum silicon alloy balls is greater than or equal to 56 wt %, and an Si content of the aluminum silicon alloy balls is greater than or equal to 40 wt %;

an Al content of the aluminum silicon iron alloy balls is 45˜60 wt %, an Si content of the aluminum silicon iron alloy balls is 30-40 wt %, and an Fe content of the aluminum silicon iron alloy balls is 5˜15 wt %;

an Al content of the aluminum silicon nickel alloy balls is 30˜40 wt %, an Si content of the aluminum silicon nickel alloy balls is 40˜50 wt %, and an Ni content of the aluminum silicon nickel alloy balls is 20˜30 wt %; and
an Mg content of the silicon magnesium alloy balls is 40˜50 wt %, and an Si content of the silicon magnesium alloy balls is 50˜60 wt %.

An Al₂O₃ content of the corundum fine powder is greater than or equal to 98 wt %; and a particle size of the corundum fine powder is less than or equal to 74 μm.

An Al₂O₃ content of the α-alumina powder is greater than or equal to 97 wt %; and a particle size of the α-alumina powder is less than or equal to 8 μm.

An Al₂O₃ content of the Guangxi clay is 33-36 wt %, a SiO₂ content of the Guangxi clay is 46-49 wt %, and a Fe₂O₃ content of the Guangxi clay is 1-1.3 wt %; and a particle size of the Guangxi clay is less than or equal to 180 μm.

A SiO₂ content of the silica fine powder is greater than or equal to 92 wt %; and a particle size of the silicon fine powder is less than or equal to 0.6 μm.

A P₂O₅ content of the aluminum dihydrogen phosphate solution is greater than or equal to 33 wt %; and an Al₂O₃ content of the aluminum dihydrogen phosphate solution is greater than or equal to 8 wt %.

An Al₂O₃ content of the mullite fine powder is greater than or equal to 68 wt %; and a particle size of the mullite fine powder is greater than or equal to 0.088 mm.

Compared with the prior art, the present disclosure has the following positive effects.

In the present disclosure, the metal balls are used as cores, and the organic ignition loss, the paraffin, the alumina refractory slurry and the mullite refractory slurry are coated in sequence. During the baking process, the water in the alumina refractory slurry and mullite refractory slurry is discharged, and through hole channels are formed in the outer shell body. During the roasting process, the paraffin melts first, and is gradually discharged through the through holes in alumina refractory slurry and mullite refractory slurry. The temperature is raised continuously, and the organic ignition loss starts oxidative decomposition, and is gradually discharged through the through holes in the alumina refractory slurry and mullite refractory slurry. The paraffin and the organic ignition loss burn out, decompose and exhaust gas sequentially at different temperature stages, so as to avoid a large amount of gas generated at the same time, which leads to the cracking of shell body of outer alumina refractory slurry and mullite refractory slurry. The paraffin and the organic ignition loss burn out and decompose in situ to form larger pores to reserve space for melting expansion of metal balls during high temperature service. As the temperature continues to rise, the mullite refractory slurry is gradually densified during sintering, and the holes contract and disappear. With the further increase of temperature, the alumina refractory slurry is gradually densified during sintering, and the holes contract and disappear. In situ, a double-shell covering shell is formed, and the metal balls are fully covered, so that a metal overflow is avoided, and at the same time, the metal is protected from being oxidized by external air. Therefore, the prepared double-shell phase change heat storage balls are encapsulated in situ, have a simple process, good sealing, strong stability and high heat storage capacity, and can improve the utilization rate of heat.

The present disclosure finally forms an alumina-mullite composite double-shell encapsulating the metal balls. A composite shell phase change heat storage particle with a core of metal and a shell of alumina-mullite is obtained. During the roasting process, the alumina refractory slurry and the mullite refractory slurry are gradually densified and finally formed into an alumina-mullite composite double-shell to wrap up the metal balls. The mullite has the advantage of good thermal shock performance and is combined with the advantage of high strength of alumina. Therefore, the prepared double-shell phase change heat storage balls have good thermal shock stability, good heat cycle performance and long service life.

The present disclosure controls the thickness and uniformity of the covering layers of the metal balls by controlling the rotation speed and the time of the metal balls in the pan granulator. Therefore, the prepared double-shell phase change heat storage balls are easy to control, the shell thickness is uniform, the stability is strong, and it is easy to industrial production.

The refractory slurry used in the present disclosure can be stabilized at 1200-1600° C. and further densified. Therefore, the prepared double-shell phase change heat storage balls can be used at a high temperature and has a wide range of applications.

After testing, the heat storage density of the double-shell phase change heat storage balls prepared by the disclosure is 160.5-310.8 J/g, and there is no crack after 20-50 thermal shocks at 1000° C., and the heat storage density is reduced by 20-30% after 3000 thermal cycles at 500-1200° C.

Therefore, the present disclosure has the features of in-situ packaging, simple process, easy control and easy industrial production. The prepared double-shell phase change heat storage balls have the advantages such as good sealing properties, strong stability and uniform shell thickness, high heat storage capacity, good thermal shock stability, good heat cycle performance, long service life and high use temperature, and the heat utilization rate can be improved.

### DETAILED DESCRIPTION OF EMBODIMENTS

The present disclosure will be further described below in conjunction with the detailed description of embodiments, and is not intended to limit its protection.

A preparation method for a double-shell phase change heat storage balls, including:

Step 1: preparing raw materials with 50-70 wt % of a paraffin and 30-50 wt % of an organic ignition loss, placing the paraffin in an oven at 80-110° C. for 1-2 h to obtain a paraffin melt; then adding the organic ignition loss to produce a paraffin melt containing the ignition loss; then immersing metal balls in the paraffin melt containing the ignition loss for 10-20 s, and naturally cooling the immersed metal balls in a fume hood to prepare metal balls coated by ignition loss and paraffin;

Step 2: placing 15-35 wt % of an alumina refractory slurry in a pan granulator, then adding 65-85 wt % of the metal balls coated by ignition loss and paraffin into the pan granulator, rotating the pan granulator at 10-20 r/min for 0.5-1 h, taking out and placing the pelletized metal balls in a fume hood for 4-6 h, and then maintaining a temperature at 80-110° C. for 20-24 h to prepare alumina composite phase change heat storage ball bodies;

Step 3: placing 25-40 wt % of a mullite refractory slurry in a pan granulator, then adding 60-75 wt % of the alumina composite phase change heat storage ball bodies into the pan granulator, rotating the pan granulator at 10-20 r/min for 0.5-1 h, taking out and placing the pelletized ball bodies in a fume hood for 4-6 h, and then placing in an oven, maintaining at 80-110° C. for 20-24 h to prepare an alumina-mullite double-shell phase change heat storage ball bodies;

Step 4: placing the alumina-mullite double-shell phase change heat storage ball bodies in a muffle furnace, increasing a temperature to 500-550° C. at a rate of 5-10° C./min, maintaining the temperature for 2-4 h, then increasing the temperature to 850-1100° C. at a rate of 3-5° C./min, maintaining the temperature for 3-5 h, then increasing the temperature to 1200-1600° C. at a rate of 2-5° C./min, maintaining the temperature for 3-5 h, and naturally cooling to room temperature to produce double-shell phase change heat storage balls.

A preparation method for the alumina refractory slurry includes:

premixing 80-90 wt % of a corundum fine powder, 3-5 wt % of an α-alumina powder, 4-8 wt % of a Guangxi clay, 1-3 wt % of a silica fine powder, 1-2 wt % of a calcium lignosulphonate and 1-2 wt % of a dextrin to obtain a premix; then adding 6-8 wt % of an aluminum dihydrogen phosphate solution and 8-10 wt % of water to the premix and stirring uniformly to prepare the alumina refractory slurry.

A preparation method for the mullite refractory slurry includes:

premixing 68-82 wt % of a mullite fine powder, 6-10 wt % of an α-alumina powder, 4-8 wt % of a Guangxi clay, 5-9 wt % of a silica fine powder, 1-2 wt % of a calcium lignosulphonate and 2-3 wt % of a dextrin to obtain a premix; then adding 6-8 wt % of an aluminum dihydrogen phosphate solution and 8-10 wt % of water to the premix and stirring uniformly to prepare the mullite refractory slurry.

The organic ignition loss is one kind of starch, sawdust and rice bran husk, and a particle size of the organic ignition loss is less than or equal to 180 μm.

The metal balls are one kind of aluminum balls, aluminum silicon alloy balls, aluminum silicon iron alloy balls, aluminum silicon nickel alloy balls and silicon magnesium alloy balls, and a particle size of the metal balls is 5-30 mm;

an Al content of the aluminum balls is greater than or equal to 97 wt %;

an Al content of the aluminum silicon alloy balls is greater than or equal to 56 wt %, and an Si content of the aluminum silicon alloy balls is greater than or equal to 40 wt %;

an Al content of the aluminum silicon iron alloy balls is 45˜60 wt %, an Si content of the aluminum silicon iron alloy balls is 30˜40 wt %, and an Fe content of the aluminum silicon iron alloy balls is 5˜15 wt %;

an Al content of the aluminum silicon nickel alloy balls is 30˜40 wt %, an Si content of the aluminum silicon nickel alloy balls is 40˜50 wt %, and an Ni content of the aluminum silicon nickel alloy balls is 20˜30 wt %; and

an Mg content of the silicon magnesium alloy balls is 40˜50 wt %, and an Si content of the silicon magnesium alloy balls is 50˜60 wt %.

An Al₂O₃ content of the Guangxi clay is 33-36 wt %, a SiO₂ content of the Guangxi clay is 46-49 wt %, and a Fe₂O₃ content of the Guangxi clay is 1-1.3 wt %; and a particle size of the Guangxi clay is less than or equal to 180 μm.

In the specific embodiments:

The particle size of the organic ignition loss is less than or equal to 180 μm.

The Al₂O₃ content of the corundum fine powder is greater than or equal to 98 wt %; and the particle size of the corundum fine powder is less than or equal to 74

The Al₂O₃ content of the α-alumina powder is greater than or equal to 97 wt %; and the particle size of the α-alumina powder is less than or equal to 8 μm.

The particle size of the Guangxi clay is less than or equal to 180 μm.

The SiO₂ content of the silica fine powder is greater than or equal to 92 wt %; and the particle size of the silicon fine powder is less than or equal to 0.6 μm.

The P₂O₅ content of the aluminum dihydrogen phosphate solution is greater than or equal to 33 wt %; and the Al₂O₃ content of the aluminum dihydrogen phosphate solution is greater than or equal to 8 wt %.

The Al₂O₃ content of the mullite fine powder is greater than or equal to 68 wt %; and the particle size of the mullite fine powder is greater than or equal to 0.088 mm.

The description will not be repeated in the embodiments.

### Embodiment 1

A preparation method for a double-shell phase change heat storage balls is provided. The steps of the preparation method described in this embodiment include:

Step 1: preparing raw materials with 50 wt % of a paraffin and 50 wt % of an organic ignition loss, placing the paraffin in an oven at 80° C. for 1 h to obtain a paraffin melt; then adding the organic ignition loss to produce a paraffin melt containing the ignition loss; then immersing metal balls in the paraffin melt containing the ignition loss for 20 s, and naturally cooling the immersed metal balls in a fume hood to prepare metal balls coated by ignition loss and paraffin;

Step 2: placing 15 wt % of an alumina refractory slurry in a pan granulator, then adding 85 wt % of the metal balls coated by ignition loss and paraffin into the pan granulator, rotating the pan granulator at 10 r/min for 1 h, taking out and placing the pelletized metal balls in a fume hood for 4 h, and then maintaining a temperature at 80° C. for 24 h to prepare alumina composite phase change heat storage ball bodies;

Step 3: placing 40 wt % of a mullite refractory slurry in a pan granulator, then adding 60 wt % of the alumina composite phase change heat storage ball bodies into the pan granulator, rotating the pan granulator at 20 r/min for 0.5 h, taking out and placing the pelletized ball bodies in a fume hood for 6 h, and then placing in an oven, maintaining at 110° C. for 20 h to prepare an alumina-mullite double-shell phase change heat storage ball bodies;

Step 4: placing the alumina-mullite double-shell phase change heat storage ball bodies in a muffle furnace, increasing a temperature to 550° C. at a rate of 10° C./min, maintaining the temperature for 2 h, then increasing the temperature to 1100° C. at a rate of 5° C./min, maintaining the temperature for 3 h, then increasing the temperature to 1600° C. at a rate of 5° C./min, maintaining the temperature for 3 h, and naturally cooling to room temperature to produce double-shell phase change heat storage balls.

A preparation method for the alumina refractory slurry includes:

premixing 80 wt % of a corundum fine powder, 5 wt % of an α-alumina powder, 8 wt % of a Guangxi clay, 3 wt % of a silica fine powder, 2 wt % of a calcium lignosulphonate and 2 wt % of a dextrin to obtain a premix; then adding 6 wt % of an aluminum dihydrogen phosphate solution and l0 wt % of water to the premix and stirring uniformly to prepare the alumina refractory slurry.

A preparation method for the mullite refractory slurry includes:

premixing 82 wt % of a mullite fine powder, 6 wt % of an α-alumina powder, 4 wt % of a Guangxi clay, 5 wt % of a silica fine powder, l wt % of a calcium lignosulphonate and 2 wt % of a dextrin to obtain a premix; then adding 8 wt % of an aluminum dihydrogen phosphate solution and 8 wt % of water to the premix and stirring uniformly to prepare the mullite refractory slurry.

The organic ignition loss is the starch.

The metal balls are the aluminum balls, the particle size of the aluminum balls is 30 mm, and the Al content of the aluminum balls is 97 wt %.

The Al₂O₃ content of the Guangxi clay is 33 wt %, the SiO₂ content of the Guangxi clay is 49 wt %, and the Fe₂O₃ content of the Guangxi clay is 1.3 wt %.

### Embodiment 2

A preparation method for a double-shell phase change heat storage balls is provided. In addition to the different Al content of the aluminum balls, the rest of the embodiment is the same as embodiment 1:

the Al content of the aluminum balls is 98 wt %.

### Embodiment 3

A preparation method for a double-shell phase change heat storage balls is provided. In addition to the different composition of the aluminum balls, the rest of the embodiment is the same as embodiment 1:

the Al content of the aluminum balls is 99 wt %.

### Embodiment 4

A preparation method for a double-shell phase change heat storage balls is provided. The steps of the preparation method described in this embodiment include:

Step 1: preparing raw materials with 57 wt % of a paraffin and 43 wt % of an organic ignition loss, placing the paraffin in an oven at 90° C. for 1.5 h to obtain a paraffin melt; then adding the organic ignition loss to produce a paraffin melt containing the ignition loss; then immersing metal balls in the paraffin melt containing the ignition loss for 16 s, and naturally cooling the immersed metal balls in a fume hood to prepare metal balls coated by ignition loss and paraffin;

Step 2: placing 21 wt % of an alumina refractory slurry in a pan granulator, then adding 79 wt % of the metal balls coated by ignition loss and paraffin into the pan granulator, rotating the pan granulator at 13 r/min for 0.8 h, taking out and placing the pelletized metal balls in a fume hood for 5 h, and then maintaining a temperature at 90° C. for 23 h to prepare alumina composite phase change heat storage ball bodies;

Step 3: placing 35 wt % of a mullite refractory slurry in a pan granulator, then adding 65 wt % of the alumina composite phase change heat storage ball bodies into the pan granulator, rotating the pan granulator at 16 r/min for 0.6 h, taking out and placing the pelletized ball bodies in a fume hood for 5 h, and then placing in an oven, maintaining at 100° C. for 21 h to prepare an alumina-mullite double-shell phase change heat storage ball bodies;

Step 4: placing the alumina-mullite double-shell phase change heat storage ball bodies in a muffle furnace, increasing a temperature to 540° C. at a rate of 9° C./min, maintaining the temperature for 3 h, then increasing the temperature to 1000° C. at a rate of 4° C./min, maintaining the temperature for 4 h, then increasing the temperature to 1500° C. at a rate of 4° C./min, maintaining the temperature for 4 h, and naturally cooling to room temperature to produce double-shell phase change heat storage balls.

A preparation method for the alumina refractory slurry includes:

premixing 83 wt % of a corundum fine powder, 4 wt % of an α-alumina powder, 8 wt % of a Guangxi clay, 2 wt % of a silica fine powder, 1.5 wt % of a calcium lignosulphonate and 1.5 wt % of a dextrin to obtain a premix; then adding 7 wt % of an aluminum dihydrogen phosphate solution and 9 wt % of water to the premix and stirring uniformly to prepare the alumina refractory slurry.

A preparation method for the mullite refractory slurry includes: premixing 77 wt % of a mullite fine powder, 6 wt % of an α-alumina powder, 6 wt % of a Guangxi clay, 7 wt % of a silica fine powder, 1.5 wt % of a calcium lignosulphonate and 2.5 wt % of a dextrin to obtain a premix; then adding 7 wt % of an aluminum dihydrogen phosphate solution and 9 wt % of water to the premix and stirring uniformly to prepare the mullite refractory slurry.

The organic ignition loss is the sawdust.

The metal balls are the aluminum silicon alloy balls, the particle size of the aluminum silicon alloy balls is 25 mm; the Al content of the aluminum silicon alloy balls is 56.1 wt %, and the Si content of the aluminum silicon alloy balls is 40 wt %.

The Al₂O₃ content of the Guangxi clay is 34 wt %, the SiO₂ content of the Guangxi clay is 48 wt %, and the Fe₂O₃ content of the Guangxi clay is 1.2 wt %.

### Embodiment 5

A preparation method for a double-shell phase change heat storage balls is provided. In addition to the different composition of the aluminum silicon alloy balls, the rest of the embodiment is the same as embodiment 4:

the Al content of the aluminum silicon alloy balls is 70.3 wt %, and the Si content of the aluminum silicon alloy balls is 28 wt %.

### Embodiment 6

A preparation method for a double-shell phase change heat storage balls is provided. In addition to the different composition of the aluminum silicon alloy balls, the rest of the embodiment is the same as embodiment 4:

the Al content of the aluminum silicon alloy balls is 86.2 wt %, and the Si content of the aluminum silicon alloy balls is 12 wt %.

### Embodiment 7

A preparation method for a double-shell phase change heat storage balls is provided. In addition to the different composition of the aluminum silicon alloy balls, the rest of the embodiment is the same as embodiment 4:

the Al content of the aluminum silicon alloy balls is 95.4 wt %, and the Si content of the aluminum silicon alloy balls is 3 wt %.

### Embodiment 8

A preparation method for a double-shell phase change heat storage balls is provided. The steps of the preparation method described in this embodiment include:

Step 1: preparing raw materials with 63 wt % of a paraffin and 37 wt % of an organic ignition loss, placing the paraffin in an oven at 100° C. for 1.5 h to obtain a paraffin melt; then adding the organic ignition loss to produce a paraffin melt containing the ignition loss; then immersing metal balls in the paraffin melt containing the ignition loss for 13 s, and naturally cooling the immersed metal balls in a fume hood to prepare metal balls coated by ignition loss and paraffin;

Step 2: placing 27 wt % of an alumina refractory slurry in a pan granulator, then adding 73 wt % of the metal balls coated by ignition loss and paraffin into the pan granulator, rotating the pan granulator at 16 r/min for 0.6 h, taking out and placing the pelletized metal balls in a fume hood for 5 h, and then maintaining a temperature at 100° C. for 22 h to prepare alumina composite phase change heat storage ball bodies;

Step 3: placing 30 wt % of a mullite refractory slurry in a pan granulator, then adding 70 wt % of the alumina composite phase change heat storage ball bodies into the pan granulator, rotating the pan granulator at 13 r/min for 0.8 h, taking out and placing the pelletized ball bodies in a fume hood for 5 h, and then placing in an oven, maintaining at 90° C. for 22 h to prepare an alumina-mullite double-shell phase change heat storage ball bodies;

Step 4: placing the alumina-mullite double-shell phase change heat storage ball bodies in a muffle furnace, increasing a temperature to 520° C. at a rate of 7° C./min, maintaining the temperature for 3 h, then increasing the temperature to 900° C. at a rate of 4° C./min, maintaining the temperature for 4 h, then increasing the temperature to 1300° C. at a rate of 3° C./min, maintaining the temperature for 4 h, and naturally cooling to room temperature to produce double-shell phase change heat storage balls.

A preparation method for the alumina refractory slurry includes:

premixing 87 wt % of a corundum fine powder, 3 wt % of an α-alumina powder, 5 wt % of a Guangxi clay, 2 wt % of a silica fine powder, 1.5 wt % of a calcium lignosulphonate and 1.5 wt % of a dextrin to obtain a premix; then adding 7 wt % of an aluminum dihydrogen phosphate solution and 9 wt % of water to the premix and stirring uniformly to prepare the alumina refractory slurry.

A preparation method for the mullite refractory slurry includes:

premixing 74 wt % of a mullite fine powder, 8 wt % of an α-alumina powder, 6 wt % of a Guangxi clay, 8 wt % of a silica fine powder, 1.5 wt % of a calcium lignosulphonate and 2.5 wt % of a dextrin to obtain a premix; then adding 7 wt % of an aluminum dihydrogen phosphate solution and 9 wt % of water to the premix and stirring uniformly to prepare the mullite refractory slurry.

The organic ignition loss is the sawdust.

The metal balls is the aluminum silicon iron alloy balls, the particle size of the aluminum silicon iron alloy balls is 20 mm; the Al content of the aluminum silicon iron alloy balls is 45 wt %, the Si content of the aluminum silicon iron alloy balls is 40 wt %, and the Fe content of the aluminum silicon iron alloy balls is 15 wt %.

The Al₂O₃ content of the Guangxi clay is 35 wt %, the SiO₂ content of the Guangxi clay is 47 wt %, and the Fe₂₀₃ content of the Guangxi clay is 1.2 wt %.

### Embodiment 9

A preparation method for a double-shell phase change heat storage balls is provided. In addition to the different composition of the aluminum silicon iron alloy balls, the rest of the embodiment is the same as embodiment 8:

the Al content of the aluminum silicon iron alloy balls is 50 wt %, the Si content of the aluminum silicon iron alloy balls is 35 wt %, and the Fe content of the aluminum silicon iron alloy balls is 15 wt %.

### Embodiment 10

A preparation method for a double-shell phase change heat storage balls is provided. In addition to the different composition of the aluminum silicon iron alloy balls, the rest of the embodiment is the same as embodiment 8:

the Al content of the aluminum silicon iron alloy balls is 60 wt %, the Si content of the aluminum silicon iron alloy balls is 30 wt %, and the Fe content of the aluminum silicon iron alloy balls is 10 wt %.

### Embodiment 11

A preparation method for a double-shell phase change heat storage balls is provided. The steps of the preparation method described in this embodiment include:

Step 1: preparing raw materials with 70 wt % of a paraffin and 30 wt % of an organic ignition loss, placing the paraffin in an oven at 110° C. for 2 h to obtain a paraffin melt; then adding the organic ignition loss to produce a paraffin melt containing the ignition loss; then immersing metal balls in the paraffin melt containing the ignition loss for 10 s, and naturally cooling the immersed metal balls in a fume hood to prepare metal balls coated by ignition loss and paraffin;

Step 2: placing 35 wt % of an alumina refractory slurry in a pan granulator, then adding 65 wt % of the metal balls coated by ignition loss and paraffin into the pan granulator, rotating the pan granulator at 20 r/min for 0.5 h, taking out and placing the pelletized metal balls in a fume hood for 6 h, and then maintaining a temperature at 110° C. for 20 h to prepare alumina composite phase change heat storage ball bodies;

Step 3: placing 25 wt % of a mullite refractory slurry in a pan granulator, then adding 75 wt % of the alumina composite phase change heat storage ball bodies into the pan granulator, rotating the pan granulator at 10 r/min for 0.5 h, taking out and placing the pelletized ball bodies in a fume hood for 4 h, and then placing in an oven, maintaining at 80° C. for 24 h to prepare an alumina-mullite double-shell phase change heat storage ball bodies;

Step 4: placing the alumina-mullite double-shell phase change heat storage ball bodies in a muffle furnace, increasing a temperature to 500° C. at a rate of 5° C./min, maintaining the temperature for 4 h, then increasing the temperature to 850° C. at a rate of 3° C./min, maintaining the temperature for 5 h, then increasing the temperature to 1200° C. at a rate of 2° C./min, maintaining the temperature for 5 h, and naturally cooling to room temperature to produce double-shell phase change heat storage balls.

A preparation method for the alumina refractory slurry includes:

premixing 90 wt % of a corundum fine powder, 3 wt % of an α-alumina powder, 4 wt % of a Guangxi clay, 1 wt % of a silica fine powder, 1 wt % of a calcium lignosulphonate and 1 wt % of a dextrin to obtain a premix; then adding 8 wt % of an aluminum dihydrogen phosphate solution and 8 wt % of water to the premix and stirring uniformly to prepare the alumina refractory slurry.

A preparation method for the mullite refractory slurry includes:

premixing 68 wt % of a mullite fine powder, 10 wt % of an α-alumina powder, 8 wt % of a Guangxi clay, 9 wt % of a silica fine powder, 2 wt % of a calcium lignosulphonate and 3 wt % of a dextrin to obtain a premix; then adding 6 wt % of an aluminum dihydrogen phosphate solution and 10 wt % of water to the premix and stirring uniformly to prepare the mullite refractory slurry.

The organic ignition loss is the rice bran husk.

The metal balls is the aluminum silicon nickel alloy balls, the particle size of the aluminum silicon nickel alloy balls is 10 mm; the Al content of the aluminum silicon nickel alloy balls is 30 wt %, the Si content of the aluminum silicon nickel alloy balls is 50 wt %, and the Ni content of the aluminum silicon nickel alloy balls is 20 wt %.

The Al₂O₃ content of the Guangxi clay is 36 wt %, the SiO₂ content of the Guangxi clay is 46 wt %, and the Fe₂O₃ content of the Guangxi clay is 1 wt %.

### Embodiment 12

A preparation method for a double-shell phase change heat storage balls is provided. In addition to the different composition of the aluminum silicon nickel alloy balls, the rest of the embodiment is the same as embodiment 11:

the Al content of the aluminum silicon nickel alloy balls is 35 wt %, the Si content of the aluminum silicon nickel alloy balls is 40 wt %, and the Ni content of the aluminum silicon nickel alloy balls is 25 wt %.

### Embodiment 13

A preparation method for a double-shell phase change heat storage balls is provided. In addition to the different composition of the aluminum silicon nickel alloy balls, the rest of the embodiment is the same as embodiment 11:

the Al content of the aluminum silicon nickel alloy balls is 40 wt %, the Si content of the aluminum silicon nickel alloy balls is 30 wt %, and the Ni content of the aluminum silicon nickel alloy balls is 30 wt %.

### Embodiment 14

A preparation method for a double-shell phase change heat storage balls is provided. The steps of the preparation method described in this embodiment include:

Step 1: preparing raw materials with 56 wt % of a paraffin and 44 wt % of an organic ignition loss, placing the paraffin in an oven at 100° C. for 1.5 h to obtain a paraffin melt; then adding the organic ignition loss to produce a paraffin melt containing the ignition loss; then immersing metal balls in the paraffin melt containing the ignition loss for 15 s, and naturally cooling the immersed metal balls in a fume hood to prepare metal balls coated by ignition loss and paraffin;

Step 2: placing 20 wt % of an alumina refractory slurry in a pan granulator, then adding 80 wt % of the metal balls coated by ignition loss and paraffin into the pan granulator, rotating the pan granulator at 15 r/min for 0.5 h, taking out and placing the pelletized metal balls in a fume hood for 5 h, and then maintaining a temperature at 90° C. for 22 h to prepare alumina composite phase change heat storage ball bodies;

Step 3: placing 30 wt % of a mullite refractory slurry in a pan granulator, then adding 70 wt % of the alumina composite phase change heat storage ball bodies into the pan granulator, rotating the pan granulator at 15 r/min for 0.5 h, taking out and placing the pelletized ball bodies in a fume hood for 5 h, and then placing in an oven, maintaining at 90° C. for 21 h to prepare an alumina-mullite double-shell phase change heat storage ball bodies;

Step 4: placing the alumina-mullite double-shell phase change heat storage ball bodies in a muffle furnace, increasing a temperature to 520° C. at a rate of 8° C./min, maintaining the temperature for 3 h, then increasing the temperature to 950° C. at a rate of 4° C./min, maintaining the temperature for 4 h, then increasing the temperature to 1400° C. at a rate of 4° C./min, maintaining the temperature for 4 h, and naturally cooling to room temperature to produce double-shell phase change heat storage balls.

A preparation method for the alumina refractory slurry includes:

premixing 85 wt % of a corundum fine powder, 5 wt % of an α-alumina powder, 4 wt % of a Guangxi clay, 3 wt % of a silica fine powder, 1 wt % of a calcium lignosulphonate and 2 wt % of a dextrin to obtain a premix; then adding 7 wt % of an aluminum dihydrogen phosphate solution and 8 wt % of water to the premix and stirring uniformly to prepare the alumina refractory slurry.

A preparation method for the mullite refractory slurry includes:

premixing 70 wt % of a mullite fine powder, 9 wt % of an α-alumina powder, 7 wt % of a Guangxi clay, 9 wt % of a silica fine powder, 2 wt % of a calcium lignosulphonate and 3 wt % of a dextrin to obtain a premix; then adding 8 wt % of an aluminum dihydrogen phosphate solution and 9 wt % of water to the premix and stirring uniformly to prepare the mullite refractory slurry.

The organic ignition loss is the rice bran husk.

The metal balls are the silicon magnesium alloy balls, the particle size of the silicon magnesium alloy balls is 5 mm; the Mg content of the silicon magnesium alloy balls is 40 wt %, and the Si content of the silicon magnesium alloy balls is 60 wt %.

The Al₂O₃ content of the Guangxi clay is 34 wt %, the SiO₂ content of the Guangxi clay is 47 wt %, and the Fe₂O₃ content of the Guangxi clay is 1.2 wt %.

### Embodiment 15

A preparation method for a double-shell phase change heat storage balls is provided. In addition to the different composition of the silicon magnesium alloy balls, the rest of the embodiment is the same as embodiment 14:

the Mg content of the silicon magnesium alloy balls is 50 wt %, and the Si content of the silicon magnesium alloy balls is 50 wt %.

Embodiment 16

A preparation method for a double-shell phase change heat storage balls is provided. In addition to the different composition of the silicon magnesium alloy balls, the rest of the embodiment is the same as embodiment 14:

the Mg content of the silicon magnesium alloy balls is 60 wt %, and the Si content of the silicon magnesium alloy balls is 40 wt %.

Compared with the prior art, the specific embodiments have the following positive effects.

In each of the specific embodiments, the metal balls are used as cores, and the organic ignition loss and the paraffin, the alumina refractory slurry and the mullite refractory slurry are coated in sequence. During the baking process, the water in the alumina refractory slurry and mullite refractory slurry is discharged, and through hole channels are formed in the outer shell body. During the roasting process, the paraffin melts first, and is gradually discharged through the through holes in alumina refractory slurry and mullite refractory slurry. The temperature is raised continuously, and the organic ignition loss starts oxidative decomposition, and is gradually discharged through the through holes in the alumina refractory slurry and mullite refractory slurry. The paraffin and the organic ignition loss burn out, decompose and exhaust gas sequentially at different temperature stages, so as to avoid a large amount of gas generated at the same time, which leads to the cracking of shell body of outer alumina refractory slurry and mullite refractory slurry. The paraffin and the organic ignition loss burn out and decompose in situ to form larger pores to reserve space for melting expansion of metal balls during high temperature service. As the temperature continues to rise, the mullite refractory slurry is gradually densified during sintering, and the holes contract and disappear. With the further increase of temperature, the alumina refractory slurry is gradually densified during sintering, and the holes contract and disappear. In situ, a double-shell covering shell is formed, and the metal balls is fully covered, so that a metal overflow is avoided, and at the same time, the metal is protected from being oxidized by external air. Therefore, the prepared double-shell phase change heat storage balls are encapsulated in situ, have a simple process, good sealing, strong stability and high heat storage capacity, and can improve the utilization rate of heat.

Each of the specific embodiments finally forms an alumina-mullite composite double-shell encapsulating the metal balls. A composite shell phase change heat storage particle with a core of metal and a shell of alumina-mullite is obtained. During the roasting process, the alumina refractory slurry and the mullite refractory slurry are gradually densified and finally formed into an alumina-mullite composite double-shell to wrap up the metal balls. The mullite has the advantage of good thermal shock performance and is combined with the advantage of high strength of alumina. Therefore, the prepared double-shell phase change heat storage balls have good thermal shock stability, good heat cycle performance and long service life.

Each of the specific embodiments controls the thickness and uniformity of the covering layers of the metal balls by controlling the rotation speed and the time of the metal balls in the pan granulator. Therefore, the prepared double-shell phase change heat storage balls are easy to control, the shell thickness is uniform, the stability is strong, and it is easy to industrial production.

The refractory slurry used in each of the specific embodiments can be stabilized at 1200-1600° C. and further densified. Therefore, the prepared double-shell phase change heat storage balls can be used at a high temperature and has a wide range of applications.

After testing, the heat storage density of the double-shell phase change heat storage balls prepared by each of the specific embodiments is 160.5-310.8 J/g, and there is no crack after 20-50 thermal shocks at 1000° C., and the heat storage density is reduced by 20-30% after 3000 thermal cycles at 500-1200° C.

Therefore, the specific embodiments have the features of in-situ packaging, simple process, easy control and easy industrial production. The prepared double-shell phase change heat storage balls have the advantages such as good sealing properties, strong stability and uniform shell thickness, high heat storage capacity, good thermal shock stability, good heat cycle performance, long service life and high use temperature, and the heat utilization rate can be improved.

1. A preparation method for a double-shell phase change heat storage balls, comprising:
Step 1: preparing raw materials with 50-70 wt % of a paraffin and 30-50 wt % of an organic ignition loss, placing the paraffin in an oven at 80-110° C. for 1-2 h to obtain a paraffin melt; then adding the organic ignition loss to produce a paraffin melt containing the ignition loss; then immersing metal balls in the paraffin melt containing the ignition loss for 10-20 s, and naturally cooling the immersed metal balls in a fume hood to prepare metal balls coated by ignition loss and paraffin;
Step 2: placing 15-35 wt % of an alumina refractory slurry in a pan granulator, then adding 65-85 wt % of the metal balls coated by ignition loss and paraffin into the pan granulator, rotating the pan granulator at 10-20 r/min for 0.5-1 h, taking out and placing the pelletized metal balls in a fume hood for 4-6 h, and then maintaining a temperature at 80-110° C. for 20-24 h to prepare alumina composite phase change heat storage ball bodies;
Step 3: placing 25-40 wt % of a mullite refractory slurry in a pan granulator, then adding 60-75 wt % of the alumina composite phase change heat storage ball bodies into the pan granulator, rotating the pan granulator at 10-20 r/min for 0.5-1 h, taking out and placing the pelletized ball bodies in a fume hood for 4-6 h, and then placing in an oven, maintaining at 80-110° C. for 20-24 h to prepare an alumina-mullite double-shell phase change heat storage ball bodies;
Step 4: placing the alumina-mullite double-shell phase change heat storage ball bodies in a muffle furnace, increasing a temperature to 500-550° C. at a rate of 5-10° C./min, maintaining the temperature for 2-4 h, then increasing the temperature to 850-1100° C. at a rate of 3-5° C./min, maintaining the temperature for 3-5 h, then increasing the temperature to 1200-1600° C. at a rate of 2-5° C./min, maintaining the temperature for 3-5 h, and naturally cooling to room temperature to produce double-shell phase change heat storage balls;
wherein a preparation method for the alumina refractory slurry comprises:
premixing 80-90 wt % of a corundum fine powder, 3-5 wt % of an α-alumina powder, 4-8 wt % of a Guangxi clay, 1-3 wt % of a silica fine powder, 1-2 wt % of a calcium lignosulphonate and 1-2 wt % of a dextrin to obtain a premix; then adding 6-8 wt % of an aluminum dihydrogen phosphate solution and 8-10 wt % of water to the premix and stirring uniformly to prepare the alumina refractory slurry; and
a preparation method for the mullite refractory slurry comprises:
premixing 68-82 wt % of a mullite fine powder, 6-10 wt % of an α-alumina powder, 4-8 wt % of a Guangxi clay, 5-9 wt % of a silica fine powder, 1-2 wt % of a calcium lignosulphonate and 2-3 wt % of a dextrin to obtain a premix; then adding 6-8 wt % of an aluminum dihydrogen phosphate solution and 8-10 wt % of water to the premix and stirring uniformly to prepare the mullite refractory slurry.

2. The preparation method for the double-shell phase change heat storage balls of claim 1, wherein the organic ignition loss is one kind of starch, sawdust and rice bran husk, and a particle size of the organic ignition loss is less than or equal to 180 μm.

3. The preparation method for the double-shell phase change heat storage balls of claim 1, herein the metal balls are one kind of aluminum balls, aluminum silicon alloy balls, aluminum silicon iron alloy balls, aluminum silicon nickel alloy balls and silicon magnesium alloy balls, and a particle size of the metal balls is 5-30 mm;
an Al content of the aluminum balls is greater than or equal to 97 wt %;
an Al content of the aluminum silicon alloy balls is greater than or equal to 56 wt %, and an Si content of the aluminum silicon alloy balls is greater than or equal to 40 wt %;
an Al content of the aluminum silicon iron alloy balls is 45˜60 wt %, an Si content of the aluminum silicon iron alloy balls is 30˜40 wt %, and an Fe content of the aluminum silicon iron alloy balls is 5˜15 wt %;
an Al content of the aluminum silicon nickel alloy balls is 30˜40 wt %, an Si content of the aluminum silicon nickel alloy balls is 40˜50 wt %, and an Ni content of the aluminum silicon nickel alloy balls is 20˜30 wt %; and
an Mg content of the silicon magnesium alloy balls is 40˜80 wt %, and an Si content of the silicon magnesium alloy balls is 50˜60 wt %.

4. The preparation method for the double-shell phase change heat storage balls of claim 1, wherein an Al₂O₃ content of the corundum fine powder is greater than or equal to 98 wt %; and a particle size of the corundum fine powder is less than or equal to 74 μm.

5. The preparation method for the double-shell phase change heat storage balls of claim 1, wherein an Al₂O₃ content of the α-alumina powder is greater than or equal to 97 wt %; and a particle size of the α-alumina powder is less than or equal to 8 μm.

6. The preparation method for the double-shell phase change heat storage balls of claim 1, wherein an Al₂O₃ content of the Guangxi clay is 33-36 wt %, a SiO₂ content of the Guangxi clay is 46-49 wt %, and a Fe₂O₃ content of the Guangxi clay is 1-1.3 wt %;
and a particle size of the Guangxi clay is less than or equal to 180 μm.

7. The preparation method for the double-shell phase change heat storage balls of claim 1, wherein a SiO₂ content of the silica fine powder is greater than or equal to 92 wt %; and a particle size of the silicon fine powder is less than or equal to 0.6 μm.

8. The preparation method for the double-shell phase change heat storage balls of claim 1, wherein a P₂O₅ content of the aluminum dihydrogen phosphate solution is greater than or equal to 33 wt %; and an Al₂O₃ content of the aluminum dihydrogen phosphate solution is greater than or equal to 8 wt %.

9. The preparation method for the double-shell phase change heat storage balls of claim 1, wherein an Al₂O₃ content of the mullite fine powder is greater than or equal to 68 wt %; and a particle size of the mullite fine powder is greater than or equal to 0.088 mm.

10. A double-shell phase change heat storage balls, wherein the double-shell phase change heat storage balls are double-shell phase change heat storage balls prepared by the preparation method for double-shell phase change heat storage balls of claim 1.
